(19) United States
(12) Patent Application Publication
(10) Pub. No.: US 2020/0316468 A1
(43) Pub. Date: Oct. 8, 2020

(54) GAME DEVICE, GAME CONTROL METHOD, AND COMPUTER-READABLE RECORDING MEDIUM HAVING STORED THEREON GAME PROGRAM

(71) Applicant: SHARP KABUSHIKI KAISHA, Sakai City (JP)

(72) Inventor: YUUKI DOI, Sakai City, Osaka (JP)

(21) Appl. No.: 16/836,041

(22) Filed: Mar. 31, 2020

(30) Foreign Application Priority Data
Apr. 2, 2019 (JP) 2019-070579

(51) Int. Cl. A63F 13/537

(52) U.S. Cl. CPC A63F 13/537

(57) ABSTRACT

A game device includes a reception processing device which receives an operation by which a user selects a plurality of objects individually, and an operation by which the user specifies an arrangement position of a selected object, which is the object selected by the user, a display control device which displays a start point and a goal point on a display screen, displays the plurality of objects in a first area on the display screen to be individually selectable, and arranges and displays, in accordance with the operation by the user, the selected object among the plurality of objects displayed in the first area at a position specified by the user in a second area between the start point and the goal point on the display screen, and a determination processing device which determines correctness of route created by the plurality of objects arranged in the second area.

### INCORPORATION BY REFERENCE

This application is based upon and claims the benefit of priority from the corresponding Japanese Patent Application No. 2019-070579 filed on Apr. 2, 2019, the entire contents of which are incorporated herein by reference.

### BACKGROUND OF THE INVENTION

### Field of the Invention

The present disclosure relates to a game device, a game control method, and a game program.

### Description of the Background Art

Conventionally, various game devices with he aim of enhancing the entertainment by not boring the players have been proposed. For example, a game system, which implements a puzzle game of forming a route by combining a plurality of panels, and a competition game which proceeds in accordance with the route formed by the puzzle game, has been proposed.

Recently, game devices with the aim of activating the brain functions to prevent dementia and the like have also been proposed. In order to realize prevention of dementia, it is desirable that the game should be able to improve the cognitive functions such as planning ability and visuospatial cognition. In this respect, with the conventional game devices, enhancement of the entertainment can be expected, but the cognitive functions such as the planning ability and visuospatial cognition are hard to be improved.

### SUMMARY OF THE INVENTION

An object of the present disclosure is to provide a game device, a game control method, and a game program capable of improving the cognitive functions of planning ability and visuospatial cognition.

A game device according to one aspect of the present disclosure relates to a game device which displays a start point and a goal point corresponding to a problem on a display screen, and also arranges and displays a plurality of objects between the start point and the goal point in accordance with an operation by a user, thereby creating a route between the start point and the goal point. The game device is provided with a display including the display screen, a reception processing device which receives an operation by which the user selects the plurality of objects individually, and an operation by which the user specifies an arrangement position of a selected object, which is an object selected by the user, from among the plurality of objects, a display control device which displays the start point and the goal point on the display screen, displays the plurality of objects in a first area on the display screen such that the plurality of objects are individually selectable by the user, and arranges and displays, in accordance the operation by the user, the selected object, which is selected by the user from among the plurality of objects displayed in the first area, at a designated position specified by the user in a second area including the start point and the goal point on the display screen, and a determination processing device which determines correctness of the route created by the plurality of objects arranged in the second area.

A game control method according to another aspect of the present disclosure relates to a game control method of displaying a start point and a goal point corresponding to a problem on a display screen, and also arranging and displaying a plurality of objects between the start point and the goal point in accordance with an operation by a user, thereby creating a route between the start point and the goal point. In the game control method, a step of displaying the start point and the goal point on the display screen, and displaying the plurality of objects in a first area on the display screen such that the plurality of objects are individually selectable by the user, a step of receiving an operation by which the user selects the plurality of objects individually, and an operation by which the user specifies an arrangement position of a selected object, which is an object selected by the user, from among the plurality of objects, a step of arranging and displaying, in accordance with the operation by the user, the selected object, which is selected by the user from among the plurality of objects displayed in the first area, at a designated position specified by the user in a second area including the start point and the goal point on the display screen, and a step of determining correctness of the route created by the plurality of objects arranged in the second area are executed by one or snore processors

A non-transitory computer-readable recording medium according to yet another aspect of the present disclosure stores a game program which displays a start point and a goal point corresponding to a problem on a display screen, and also arranges and displays a plurality of objects between the start point and the goal point in accordance with an operation by a user, thereby creating a route between the start point and the goal point. The game program causes one or more processors to execute: a step of displaying the start point and the goal point on the display screen, and displaying the plurality of objects in a first area on the display screen such that the plurality of objects are individually selectable by the user, a step of receiving an operation by which the user selects the plurality of objects individually, and an operation by which the user specifies an arrangement position of a selected object, which is the object selected by the user, from among the plurality of objects, a step of arranging and displaying, in accordance with the operation by the user, the selected object, which is selected by the user from among the plurality of objects displayed in the first area, at a designated position specified by the user in a second area including the start point and the goal point on the display screen, and a step of determining correctness of the route created by the plurality of objects arranged in the second area.

According to the present disclosure, it is possible to improve the cognitive functions of planning ability and visuospatial cognition.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a configuration of a game device according to an embodiment of the present disclosure;

FIG. 2A is a diagram illustrating an example of a level selection screen displayed on a display according to the embodiment of the present disclosure;

FIG. 2B is a diagram illustrating an example of a game screen displayed on the display according to the embodiment of the present disclosure;

FIG. 2C is a diagram illustrating another example of the game screen displayed on the display according to the embodiment of the present disclosure;

FIG. 2D is a diagram illustrating yet another example of the game screen displayed on the display according to the embodiment of the present disclosure;

FIG. 2E is diagram illustrating yet another example of the game screen displayed on the display according to the embodiment of the present disclosure;

FIG. 2F is a diagram illustrating yet another example of the game screen displayed on the display according to the embodiment of the present disclosure;

FIG. 3A is a diagram illustrating yet another example of the game screen displayed on the display according to the embodiment of the present disclosure;

FIG. 3B is a diagram illustrating yet another example of the game screen displayed on the display according to the embodiment of the present disclosure;

FIG. 3C is a diagram illustrating yet another example of the game screen displayed on the display according to the embodiment of the present disclosure;

FIG. 3D is a diagram illustrating yet another example of the game screen displayed on the display according to the embodiment of the present disclosure;

FIG. 3E is diagram illustrating yet another example of the game screen displayed on the display according to the embodiment of the present disclosure;

FIG. 4 is a diagram illustrating an example of a map in the game device according to the embodiment of the present disclosure;

FIG. 5A is a diagram illustrating an example of a piece in the game device according to the embodiment of the present disclosure;

FIG. 5B is a diagram illustrating another example of the piece in the game device according to the embodiment of the present disclosure;

FIG. 5C is a diagram illustrating yet another example of the piece in the game device according to the embodiment of the present disclosure;

FIG. 6 is a table illustrating an example of map information used in the game device according to the embodiment of the present disclosure;

FIG. 7 is a table illustrating an example of piece information used in the game device according to the embodiment of the present disclosure;

FIG. 8A is a diagram illustrating an example of a position of the piece arranged on the map of the game device according to the embodiment of the present disclosure;

FIG. 8B is a diagram illustrating another example of the position of the piece arranged on the map of the game device according to the embodiment of the present disclosure;

FIG. 8C is a diagram illustrating yet another example of the position of the piece arranged on the map of the game device according to the embodiment of the present disclosure;

FIG. 9 is a diagram illustrating an example of a grid of the map in the game device according to the embodiment of the present disclosure;

FIG. 10 is a flowchart for explaining an example of the steps of game control processing in the game device according to the embodiment of the present disclosure;

FIG. 11 is a flowchart for explaining an example of the steps of piece display processing, which is a part of the game control processing, in the game device according to the embodiment of the present disclosure; and

FIG. 12 is a flowchart for explaining an example of the steps of correctness determination processing, which is a part of the game control processing, in the game device according; to the embodiment of the present disclosure.

### DESCRIPTION OF THE PREFERRED EMBODIMENTS

Hereinafter, embodiments of the present disclosure will be described with reference to the accompanying drawings. Note that the embodiment described below is merely example embodying the present disclosure, and is not intended to limit the technical scope of the present disclosure.

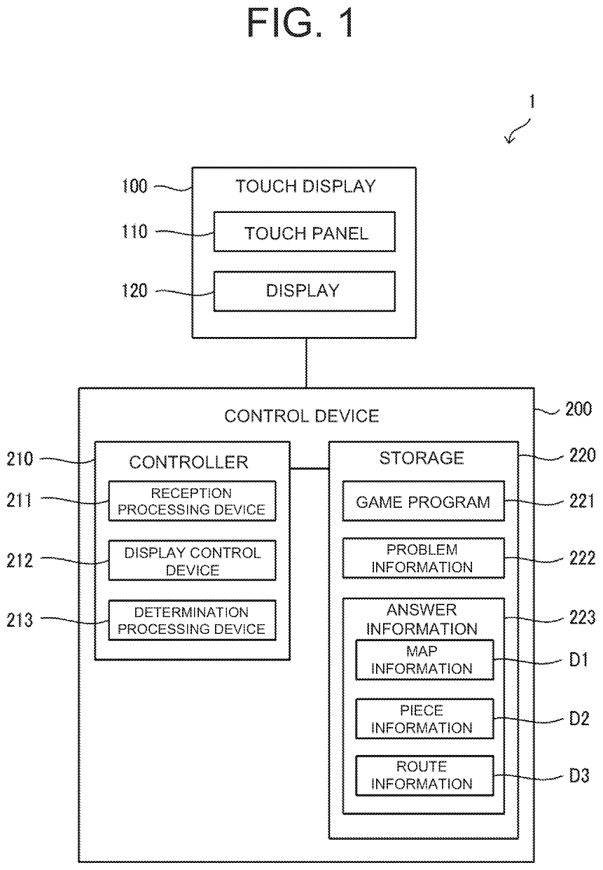

As illustrated in FIG. 1, a game device 1 according to the embodiment of the present disclosure includes a touch display 100 and a control device 200. The control device 200 is a computer which is connected to the touch display 100, and controls the touch display 100.

The touch display 100 includes a touch panel 110 and a display 120. The touch pane 110 may be a capacitive touch panel, or a pressure-sensitive or infrared interception touch panel. More specifically, the touch panel 110 may be any device which is capable of appropriately receiving an operation input by a user such as a touch operation by the user's finger or a stylus. The touch panel 110 is provided on the display 120. The display 120 is, for example, a liquid crystal display. The display 120 is not limited to a liquid crystal display, but may be a light-emitting diode (LED) display, an organic electro-luminescence (EL) display, or the like. The touch display 100 may be a device such as a computer, a tablet terminal, or a smartphone.

The game device 1 is to display a start point and a goal point on a display screen, and also to arrange and display a plurality of objects between the start point and the goal point in accordance with the operation by the user, thereby creating a route between the start point and the goal point. In the following, a method of playing a game in the game device 1 will be described. The game mentioned above is a game in which the user (a game player) sequentially selects a desired piece from among a plurality of pieces (panels) prepared in advance, and arranges the selected piece at a point on at least one square of a plurality of squares formed as segments in matrix, schematically, to connect the start point to the goal point by partial routes assigned to the respective pieces. In the following, a specific procedure for a method of playing the game will be described.

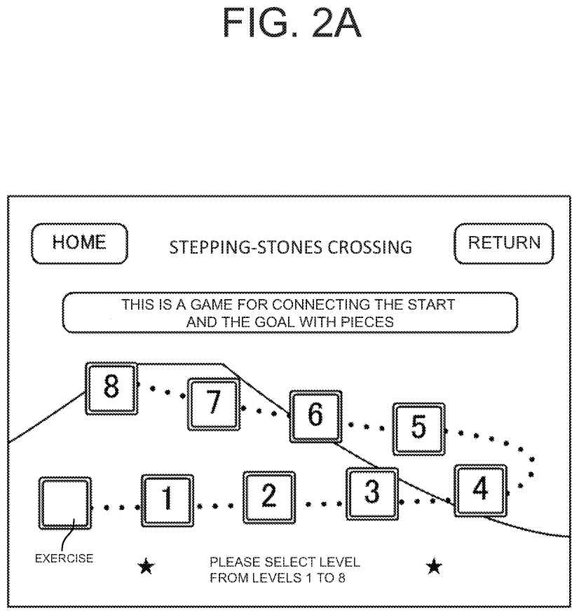

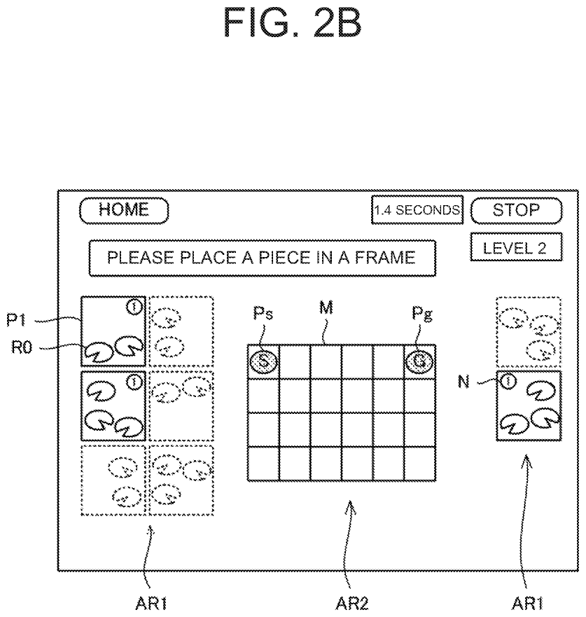

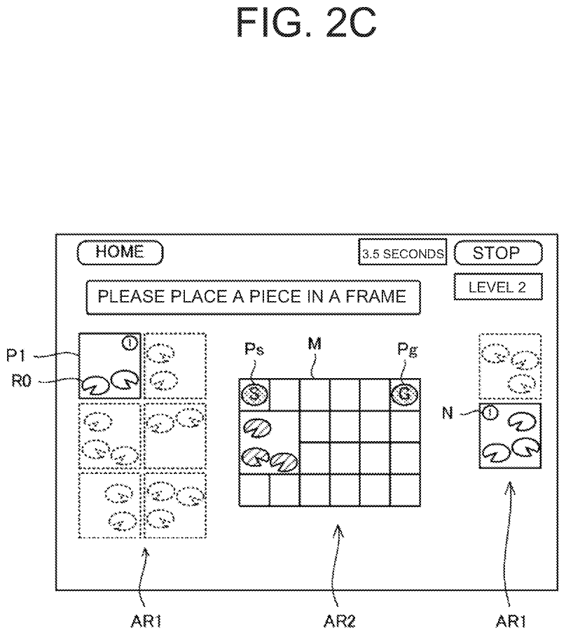

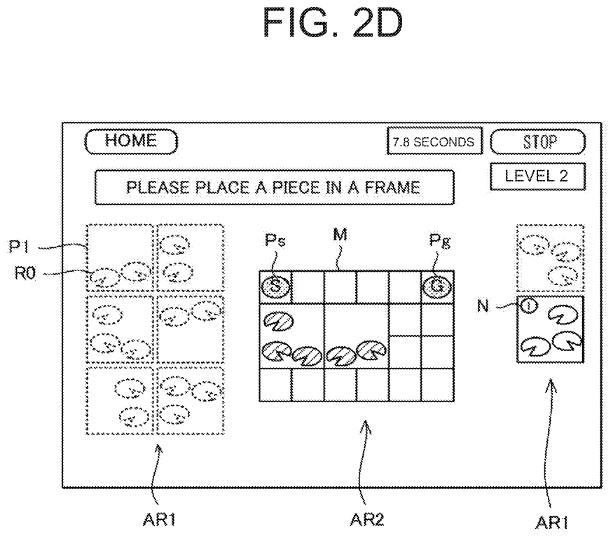

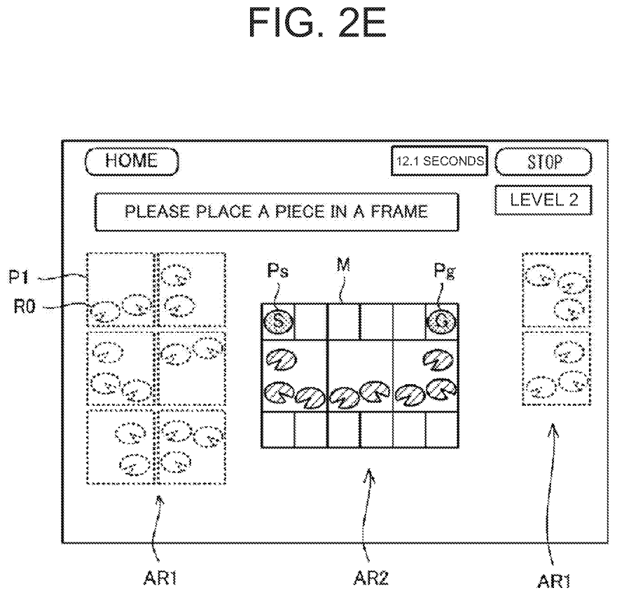

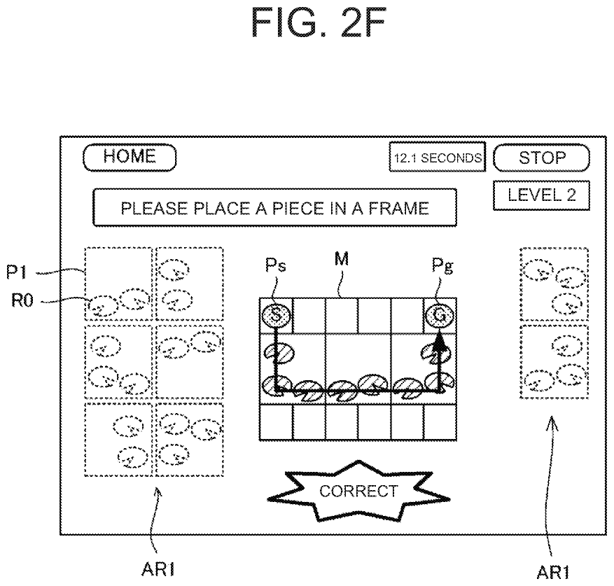

First, when the user activates the game in the game device 1, a level selection screen shown in FIG. 2A is displayed on the display 120 (the display screen) of the game device 1. In the game device 1, according to the degree of difficulty of the game (problem), for example, a game of level 1, which is the game of the lowest difficulty level, to a game of level 8, which is the game of the highest difficulty level, are registered. The user selects a desired level on the level selection screen.

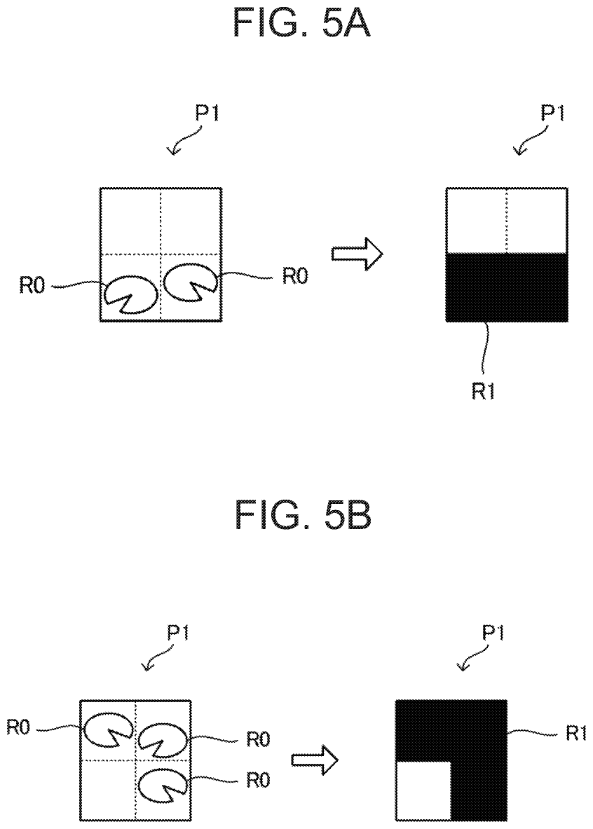

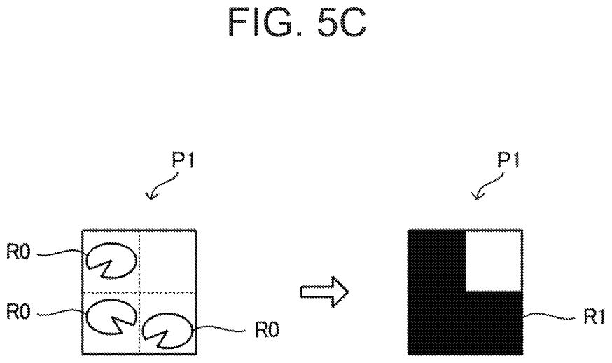

When the user selects level 2, for example, a start screen shown in FIG. 2B is displayed on the display 120. In an area AR2 (corresponding to a second area of the present disclosure) at the central part of the start screen, a map M segmented into a plurality of squares (hereinafter, referred to as cells) is displayed. Here, the map M is composed of 4×6 (=24) cells. A start point Ps s displayed in a certain cell of the map M, and a goal point Pg is displayed in a different cell. Also, in an area AR1 (corresponding to a first area of the present disclosure) on both sides of the start screen, a plurality of pieces P1 (corresponding to the objects of the present disclosure) to be arranged on the map M are displayed in such a way that the pieces P1 are selectable. The area AR1 and the area AR2 are areas different from each other on the display screen. Each of the pieces P1 has a size corresponding to four cells (i.e., two longitudinally arranged cells×two laterally arranged cells) In addition, in each piece P1, a route element R0 is arranged at a position corresponding to the cell, and a partial route composed of the route elements R0 is associated therewith. For example, in the example shown in FIG. 5A, two route elements R0 are arranged in the lower row of the piece P1, and a partial route R1 is formed by these two adjacent route elements R0. More specifically, in the piece P1 shown in FIG. 5A, the partial route R1 is associated with the lower row. Also, in the example shown in FIG. 5B, three route elements R0 are arranged in the upper row and the right column of the piece P1, and a partial route R1 is formed by these three adjacent route elements R0. In other words, in the piece P1 shown in FIG. 5B, the partial route R1 is associated with the upper row and the right column. Similarly, in the piece P1 shown in FIG. 5C, the partial route R1 is associated with the lower row and the left column.

Also, information on selection permitted number N (i.e., the number of times permitted to select the piece P1) is displayed for each of the plurality of pieces P1 for use in the problem of the level selected by the user, with respect to the plurality of pieces P1 displayed in the area AR1. Here “1” representing the selection permitted number N is displayed for each of the three pieces P1 for use in the problem shown in FIG. 2B. That is, in the above problem, each one of the three pieces P1 to which “1” is assigned can be used. In FIG. 2B, for convenience, pieces P1 that can be selected in the above problem are represented by a solid line, and pieces P1 that cannot be selected are represented by a dotted line. However, the pieces P1 may be displayed in a way other than the above.

When a game is started, a timer starts to measure the time. The elapsed time is displayed on the display 120. When the game is started, the user selects a desired piece P1 from among the plurality of pieces P1. For example, the user selects a desired piece P1 from among three selectable pieces P1. Next, the user specifies a desired position on the map M. For example, the user selects the piece P1 so that the route element R0 is connected to (adjoins to) to the start point Ps, and specifies the position for arrangement. Then, as shown in FIG. 2C, the piece P1 selected by the user (corresponding to the selected object of the present disclosure) is arranged and displayed at a position (designated position) specified by the user. Note that the user arranges the piece P1 at a desired position on the map M by performing a drag-and-drop operation on the piece P1. When the piece P1 is selected by the user, the selection permitted number N is decremented by one. Here, since the selection permitted number N becomes “0”, the above-mentioned piece P1 is already used, and cannot be selected any more.

Next, the user selects a desired piece P1 from among the two remaining selectable pieces P1, and specifies the desired position on the map M. For example, the user selects the piece P1 so that the route element R0 of this piece P1 adjoins to the route element R0 of the other piece P1, and specifies the position for arrangement. Then, as shown in FIG. 2D, the piece P1 selected by the user is arranged and displayed at the designated position specified by the user. In this way, the partial routes R1 are connected continuously from the start point Ps. Also, at this point, since the selection permitted number N of the piece P1 selected by the user becomes “0” as the selection permitted number N is decremented by one, the piece P1 is already used, d cannot be selected any more.

Similarly, the user selects one remaining selectable piece P1, and specifies the desired position on the map M. For example, the user selects the piece P1 so that the route element R0 of this piece P1 adjoins to the route element R0 of the other piece P1, and specifies the position for arrangement. Then, as shown in FIG. 2E, the piece P1 selected by the user is arranged and displayed at the designated position specified by the user. Also, at this point, the selection permitted number N of the piece P1 selected by the user becomes “0” as the selection permitted number N is decremented by one, the piece P1 is already used, and cannot be selected any more. Consequently, all of the pieces P1 set for the problem as described above are used.

Further, as shown in FIG. 2F, in a case where a route following the route elements R0 is created from the start point Ps, there exists no branching point on the created route, an end point of the route matches with the goal point Pg, and the length of the route matches with the length of the correct route of the problem, it is determined that the created route is correct. In other words, when a route from the start point Ps to the goal point Pg is connected with a single stroke through the shortest route continuously, the route is determined as being correct.

Here, as the degree of difficulty of the game is increased, the number of cells is increased, for example, and a transit point is added. In a problem including the transit point, the transit point being included on a route from the start point to the goal point is one of conditions for being correct. A procedure for a playing method in which the above problem is to be solved will be described. Note that the same explanation as that given for the problem already described will not be repeated.

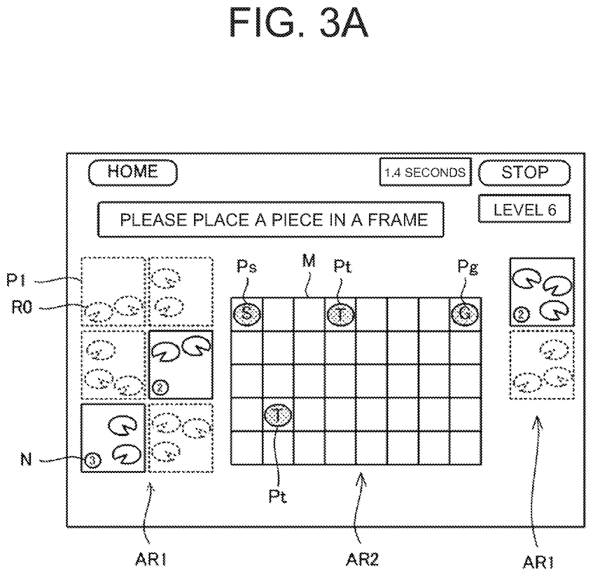

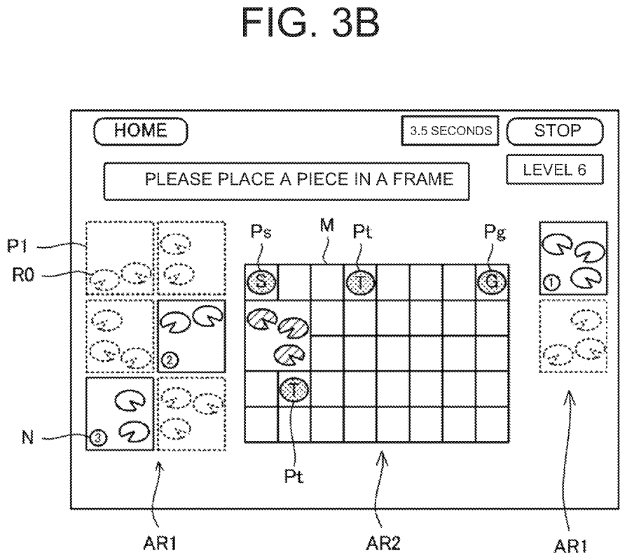

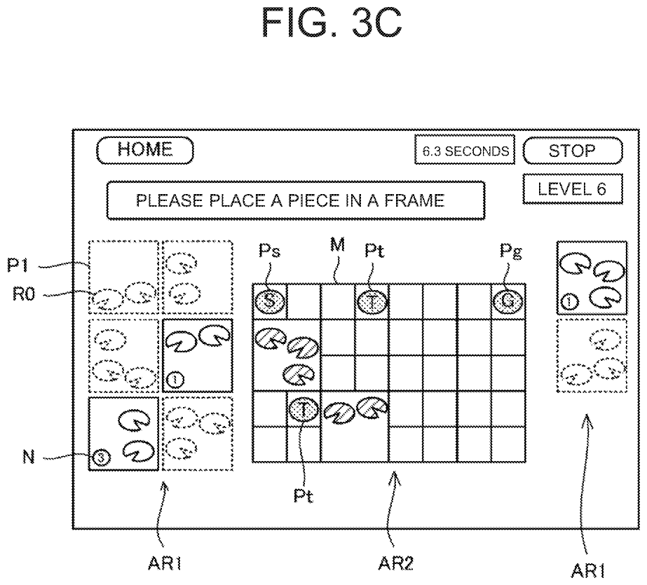

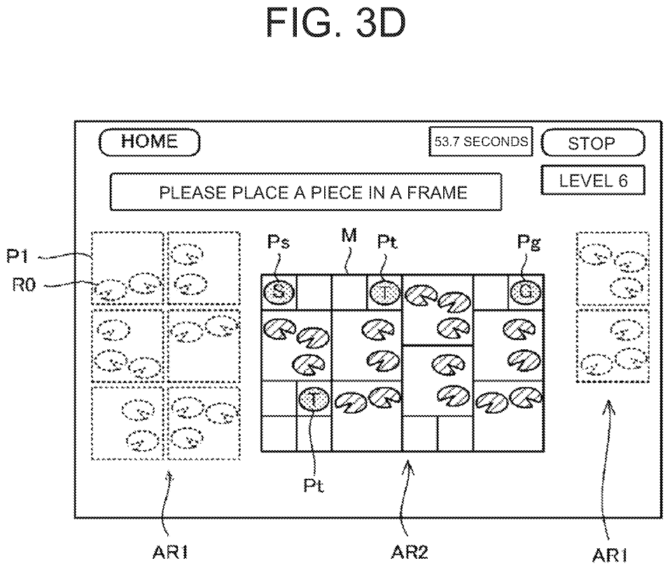

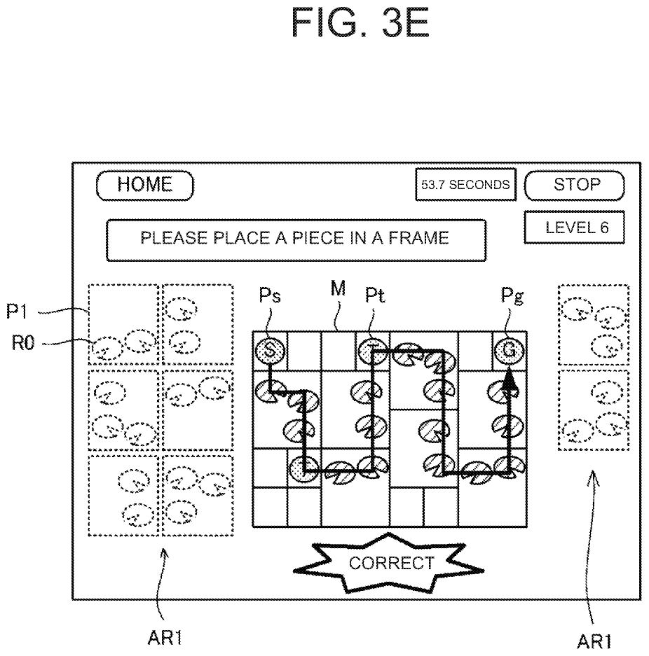

When the user selects level 6, for example, a start screen shown in FIG. 3A is displayed on the display 120. In the area AR2, the map M segmented into 5×8 (=40) cells is displayed. The start point Ps is displayed in a certain cell of the map M, the goal point Pg is displayed in a different cell. Further, a transit point Pt is displayed in each of two different cells. In this problem, seven pieces P1 are set to be selectable.

For example, the user selects a desired piece P1 from among seven selectable pieces P1. Next, the user specifies a desired position on the map M For example, the user selects the piece P1 so that the route element R0 adjoins to the start point Ps, and specifies the position for arrangement. Then, as shown in FIG. 3B, the piece P1 selected by the user is arranged and displayed at the designated position specified by the user. With respect to the piece P1 selected by the user, the selection permitted number N is updated from “2” to “1”.

Next, the user selects a desired piece P1 from among the six remaining selectable pieces P1, and specifies the desired position on the map M. For example, the user selects the piece P1 so that the route element R0 of the selected piece P1 adjoins to the route element R0 of the other piece P1 or the transit point Pt, and specifies the position for arrangement. Then, as shown in FIG. 3C, the piece P1 selected by the user is arranged and displayed at the designated position specified by the user. In this way, the partial routes R1 are connected continuously from the start point Ps by way of the transit point Pt.

Similarly, the user selects and arranges the remaining five selectable pieces P1 one by one. FIG. 3D shows the state in which all of the selectable pieces P1 are arranged.

According to the arrangement of FIG. 3D, as shown in FIG. 3E, a route following the route elements R0 and the transit points Pt is created from the start point Ps, there exists no branching point on the created route, an end point of the route matches with the goal point Pg, and the length of the route matches with the length of the correct route of the problem. Thus, it is determined that the created route is correct.

As described above, the game s to create a route by using all of the pieces P1 set for the problem while passing all the checkpoints (transit points Pt) in the middle on the way from the start point to the goal point. In this way cognitive functions such as planning ability and visuospatial cognition can be improved.

Next, a specific configuration of the control device 200 for implementing the game will be described. As shown in FIG. 1, the control device 200 includes a controller 210 and a storage 220.

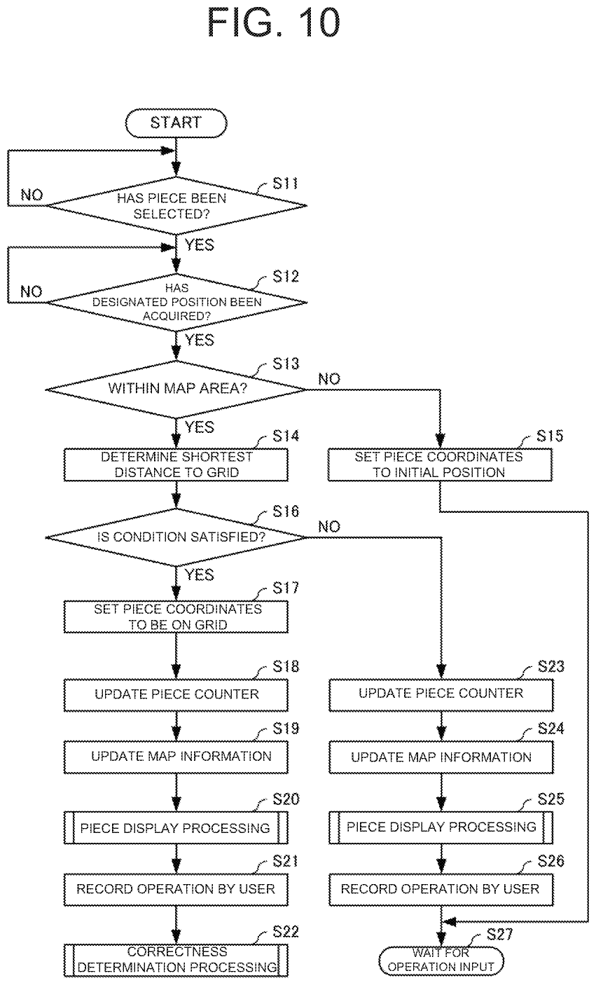

The storage 220 is a nonvolatile storage including a semiconductor memory, a hard disk drive (HDD) or a solid-state drive (SSD) for storing various kinds of information. For example, the storage 220 stores a control program, such as a game program 221, for causing the controller 210 to execute game control processing (FIGS. 10 to 12) to be described later. For example, the game program 221 is recorded on a computer-readable recording medium such as a universal serial bus (USB), a compact disc (CD), or a digital versatile disc (DVD) in a non-transitory way, is read by a reader (not shown) such as a USB drive, a CD drive, or a DVD drive that is electrically connected to the control device 200, and stored in the storage 220. The game program 221 may be downloaded from an external device via a network and stored in the storage 220.

Also, the storage 220 stores a plurality of problems according to the level. Specifically, the storage 220 stores problem information 222 regarding a plurality of problems. In the problem information 222, items of information such as the map M, the pieces P1, the start point Ps, the transit points Pt, the goal point Pg, and the correct route according to the level are registered. Note that the map M and the correct route may be automatically generated by the controller 210 when the level is selected by the user.

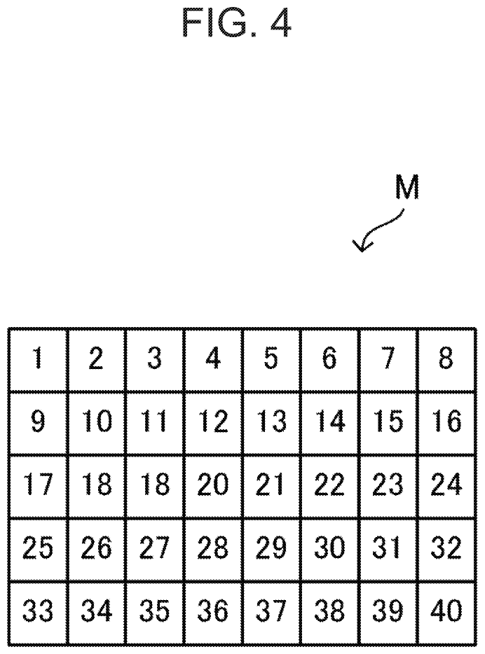

FIG. 4 shows an example of the map M. A cell number is associated with each cell of the map M. The map M shown in FIG. 4 is the map M corresponding to the problem of level 6 described above, and the cell numbers from 1 to 40 are associated with the map M. In the example shown in FIG. 4, the map M is composed of 5×8 (=40) cells. However, the map M is not limited to the above, and is composed of M×N cells according to the problem (level). Also, each of FIGS. 5A to 5C shows an example of the piece P1. FIG. 5A shows the piece P1 in which the partial route R1 is associated with the lower row. FIG. 5B shows the piece P1 in which the partial route R1 is associated with the upper row and the right column. FIG. 5C shows the piece P1 in which the partial route R1 is associated with the lower row and the left column. In the examples shown in FIGS. 5A to 5, the piece P1 is composed of 2×2 (=4) cells. However, the piece P1 is not limited to the above, and is composed of m×n cells according to the problem (level).

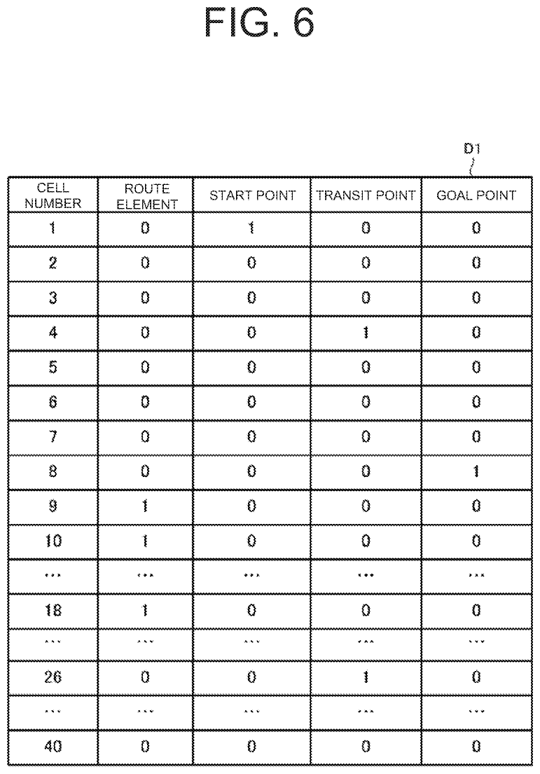

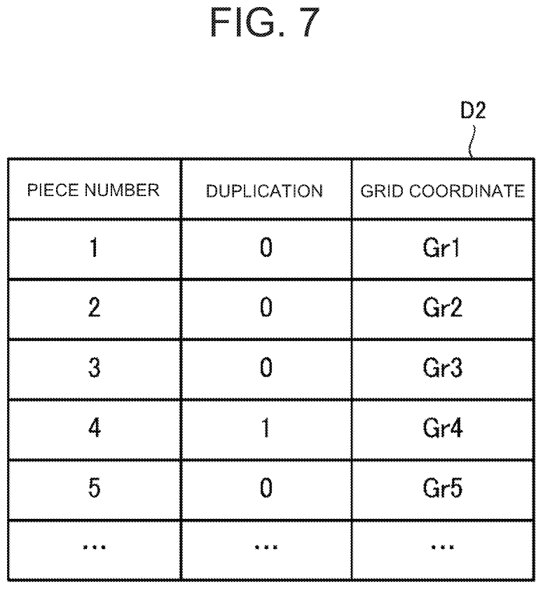

Further, the storage 220 stores answer information 223 regarding the user's answer. The answer information 223 includes map information D1, piece information D2, and route information D3. FIG. 6 is a table illustrating an example of the map information D1, and FIG. 7 is a table illustrating an example of the piece information D2.

As shown in FIG. 6, the map information D1 includes information on the “cell number”, “route element”, “start point”, “transit point”, and “goal point” for each of the cells included in the map M (FIG. 4). The “cell number” corresponds to identification information for identifying the cell. For example, as shown in FIG. 4, the cell numbers are associated with the cells, respectively. The “route element” corresponds to information indicating whether the route element R0 is arranged in the cell. For example, when the piece P1 is arranged on the map M as shown in FIG. 3B, the route element R0 is arranged in each of the cells with the cell numbers “9”, “10”, and “18”. Therefore, “1” is registered in the field of “route element” for each of these cells. In contrast, “0” is registered in the field of “route element” for the cells in which the route element R0 is not arranged. Note that FIG. 6 shows the state of FIG. 3B. The data in the field of “route element” is updated every time the piece P1 is arranged on the map M.

The “start point” corresponds to information indicating whether the start point Ps is arranged in the cell. For example, in FIG. 3B the start point Ps is arranged in the cell with the cell number “1”. Therefore, “1” is registered in the field of “start point” of the cell number “1”. The “transit point” corresponds to information indicating whether the transit point Pt is arranged in the cell. For example, in FIG. 3B, the transit point Pt is arranged in each of the cells with the cell numbers “4” and “26”. Therefore, “1” is registered in the field of “transit point” of the cell numbers “4” and “26”. The “goal point” corresponds to information indicating whether the goal point Pg is arranged in the cell. For example, in FIG. 3B, the goal point Pg is arranged in the cell with the cell number “8”. Therefore, “1” registered in the field of “goal point” of the cell number “8”. It should be noted that “0” is registered in the fields of “start point”, “transit point”, and “goal point” corresponding to each of the cells in which the start point Ps, the transit point Pt, and the goal point Pg are not arranged.

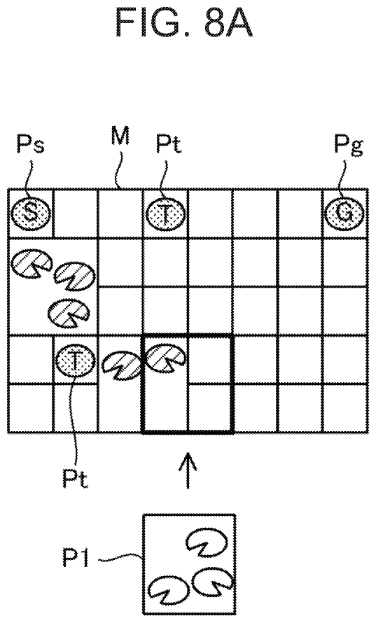

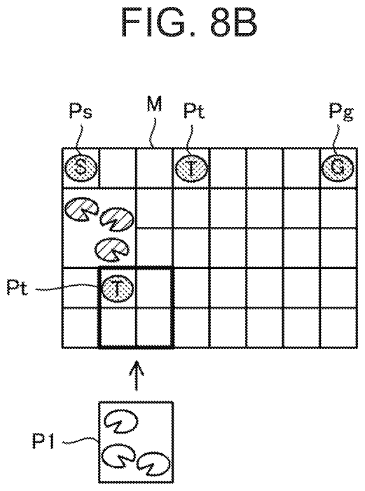

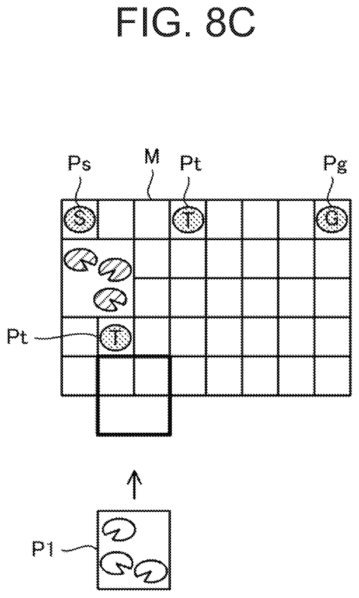

As shown FIG. 7, the piece information D2 incudes information on “piece number”, “duplication”, and “grid coordinates” for each of the pieces P1 selected by the user. The “piece number” corresponds to identification information for identifying the piece. For example, in the order in which the pieces are selected by the user, the number is associated with the piece P1. The “duplication” corresponds to information indicating whether the piece P1 selected by the user and arranged on the map M overlaps a different piece P1 already arranged on the map M, the start point Ps, the transit point Pt, or the goal point Pg. For example, as shown in FIG. 8A, when the piece P1 selected by the user is arranged in a thick line frame area, a part of the selected piece P1 overlaps the other piece P1 already arranged on the map M. Therefore, “1” is registered in the field of “duplication” corresponding to each of the overlapping two pieces P1. Also, as shown in FIG. 8B, when the piece P1 selected by the user is arranged in a thick line frame area, a part of the selected piece P1 overlaps the transit point Pt. Therefore, “1” is registered in the field of “duplication” corresponding to the selected piece P1. Note that the piece P1 for which “1” is registered in the field of “duplication” may be displayed in a color (for example, red) different from the color (for example, green) of the other piece P1 already arranged on the map M so that the overlapping piece is distinguishable on the display screen.

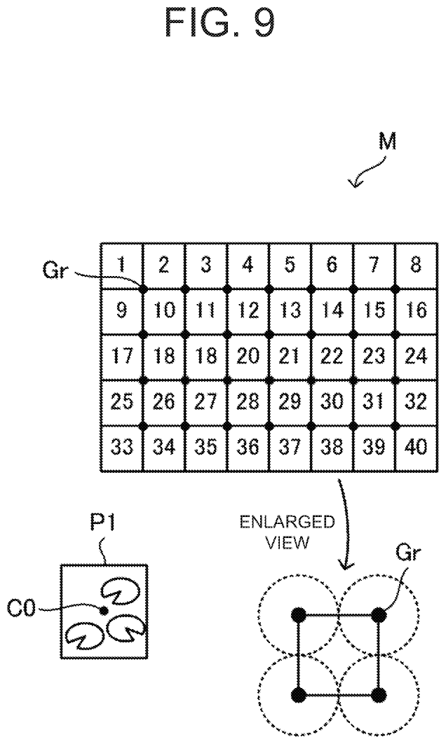

The “grid coordinates” correspond to information indicating the position of the piece P1 arranged on the map M. For example, as shown in FIG. 9, the map M includes intersections (grids Gr) of a lattice delimiting the respective cells. When the user arranges the piece P1 at an arbitrary position of the map M, the grid Gr located at the shortest distance from the center C0 of the piece P1 is specified. For example, among four circles whose respective centers are the four grids Gr, the grid Gr of the circle in which the center C0 of the piece P1 is positioned is specified as the shortest distance grid Gr. The piece P1 is positioned such that the center C0 overlaps the specified grid Gr, and is arranged on the map M. In the field of “grid coordinates”, information indicating the grid Gr (for example, the coordinates) at which the center C0 of the piece P1 overlaps is registered.

Here, when the center C0 of the piece P1 is located in an area outside the above-mentioned four circles, the shortest distance grid Gr is not specified, and specific information indicating error or indefiniteness is registered in the field of “grid coordinates” of such a piece P1. Also, in the above case, the map information D1, specific information indicating error or indefiniteness is registered is in the field of “route element” of the cell corresponding to the coordinates of the above piece P1. If the user changes the position of the piece P1, and the coordinates of the grid Gr are set on the piece P1, the coordinates of the grid Gr are registered in the field of “grid coordinates”, and the specific information in the field of “route element” is updated to represent the presence or absence (i.e., “1” or “0”) of the route element R0.

In the route information D3, the route answered by the user is registered. For example, when the route created in accordance with the operation by the user is correct, the created route (answered route) is registered in the route information D3.

The controller 210 includes control devices such as a CPU, a ROM, and a RAM. The CPU is a processor which executes various types of arithmetic processing. The ROM is a nonvolatile storage in which control programs such as a BIOS and an OS for causing the CPU to execute various types of arithmetic processing are stored in advance. The RAM is a volatile or nonvolatile storage storing various kinds of information, and is used as a temporary storage memory (work area) for various types of processing to be executed by the CPU. Further, as the controller 210 causes the CPU to execute various control programs stored in advance in the ROM or the storage 220, the control device 200 is controlled.

Specifically, the controller 210 includes processing devices such as a reception processing device 211, a display control device 212, and a determination processing device 213. The controller 210 functions as various processing devices as described above as the CPU executes various types of processing according to the game program 221. Also, a part of or all of the processing devices included in the controller 210 may be configured by an electronic circuit. Further, the game program 221 may be a program for causing a plurality of processors to function as the various processing devices described above.

The reception processing device 211 receives an operation by the user on the touch panel 110, and acquires information corresponding to the operation. For example, the reception processing device 211 receives operations such as an operation by which the user selects a plurality of pieces P1 individually, and an operation by which the user specifies an arrangement position of the piece P1 selected by the user from among the plurality of pieces P1. Apart from the above, the reception processing device 211 receives, for example, an operation of selecting the level when the user starts the game. The reception processing device 211 is an example of the reception processing device of the present disclosure.

The display control device 212 causes various kinds of information to be displayed on the display 120 (display screen). The display control device 212 is an example of the display control device of the present disclosure. For example, the display control device 212 displays a level selection screen (FIG. 2A), a game screen for the game in progress, and the like, on the display screen. In addition, for example, the display control device 212 displays the map M, the start point Ps, the transit point Pt, and the goal point Pg in the area AR2 on the display screen. Specifically, when the level of the problem is selected by the user, the display control device 212 displays the map M, the start point Ps, the transit point Pt, and the goal point Pg according to the level in the area AR2 by referring to the problem information 222. Also, the display control device 212 displays a plurality of pieces P1 in the area AR1 on the display screen in such a way that the plurality of pieces P1 can be selected by the user individually. For example, when the level of the problem is selected by the user, the display control device 212 refers to the problem information 222, and displays the plurality of pieces P1 according to the level in the area AR1. Further, the display control device 212 displays the selection permitted number N on each of the plurality of pieces P1 for use in the problem of the level selected by the user, with respect to the plurality of pieces P1 displayed in the area ARI. Furthermore, the display control device 212 decrements the selection permitted number N (performs a countdown display) each time the piece P1 is selected by the user. The display control device 212 may display common pieces P1 for all of the problems in common, or display different types of pieces P1 depending on the problem. The user selects the plural it, of pieces P1 displayed in the area AR1 individually.

In addition, the display control device 212 arranges and displays the piece P1, which is selected by the user from among the plurality of pieces P1 displayed in the area AR1, at the designated position specified by the user on the map M being displayed in the area AR2. Further, when the piece P1 selected by the user overlaps the other piece already arranged on the map M or the transit point Pt, etc., the display control device 212 causes the selected piece P1 to be displayed in a color different from the color of the other piece P1. Also, in this case, the display control device 212 may display information (a message) indicating that the piece P1 is overlapping.

Also, the display control device 212 displays the level selection screen (FIG. 2A) and the game screen for the game in progress, for example, on the display 120. Further, the display control device 212 may display, on the display 120, a performance results screen showing the result of the game when the game is ended. On the performance results screen, the time taken from the start of the game to give the correct answer, the past results, and the current level, for example, may be displayed.

The determination processing device 213 determines the correctness of the route created by the plurality of pieces P1 arranged on the map M. The determination processing device 213 is an example of the determination processing device of the present disclosure. The route is created as the partial routes R1 respectively included in the plurality of pieces P1 are connected continuously. In other words, the determination processing device 213 determines the correctness of the created route by assuming a plurality of partial routes R1, which are continuous of the whole of the plurality of partial routes R1 included in the plurality of pieces P1 arranged on the map M to be an integrated route.

The determination processing device 213 determines that the route is correct based on the premise that at least the created route connects the start point Ps and the goal point Pg as a first condition (FIGS. 2F and 3E). The determination processing device 213 may be configured to determine that the route is correct when the conditions described below are further satisfied.

For example, in addition to the above first condition, the determination processing device 213 may determine that the route is correct further on condition that the length of the route matches with a predetermined length of the route set for the problem. The predetermined length is, for example, the length of the correct route registered in the problem information 222.

Also, in addition to the above first condition, the determination processing device 213 may determine that the route is correct further on condition that all of the pieces P1 set for the problem are arranged in the area AR2. For example, the determination processing device 213 determines that the route is correct when three pieces P1 are arranged in the area AR2 in the problem shown in FIG. 2B, and determines that the route is correct when seven pieces P1 are arranged in the area AR2 in the problem shown in FIG. 3A.

Moreover, in addition to the above first condition, the determination processing device 213 may determine that the route is correct further on condition that, the route is not branched in the middle of the route. In other words, the determination processing device 213 determines that the route is correct when the route from the start point Ps to the goal point Pg is connected with a single stroke without being branched in the middle.

Moreover, in addition to the above first condition, the determination processing device 213 may determine that the route is correct further on condition that the route passes the transit point Pt (FIG. 3E).

The determination processing device 213 executes the determination processing each time the piece P1 is arranged on the map M when the game is started. When the determination processing device 213 determines that the given answer is correct, the display control device 212 displays information indicating that the answer is correct on the display screen (FIGS. 2F and 3E).

During a period from when the game is started to when the determination processing device 213 determines that the route is correct, the reception processing device 211 receives a selection operation of selecting the piece P1 by the user, an arrangement operation of arranging the piece P1 on the map M, a change operation of changing the position of the piece P1 arranged on the map M, and the like, the display control device 212 executes display processing on the piece P1 in response to the above operations, and the determination processing device 213 performs the determination processing. When the user ends the game in the middle, the reception processing device 211, the display control device 212, and the determination processing device 213 terminate the corresponding processing.

### Game Control Processing

Hereinafter, with reference to FIGS. 10, 11, and 12, one example of the steps of the game control processing to be executed by the controller 210 of the control device 200 will be described. The game control processing is an example of the game control method of the present disclosure. Note that the present disclosure can be considered as an invention of a game control method of executing one or more steps included in the game control processing.

Further, one or more steps included in the game control processing described in the present specification may be omitted as appropriate. Furthermore, the order of execution of each step in the above-mentioned game control processing may be varied as long as a similar effect and advantage can be obtained. In the present specification, a case where each step in the game control processing is executed by the controller 210 will be described as an example. However, n the other embodiments, the respective steps of the game control processing may be executed by a plurality of processors in a decentralized way.

The game control processing is started when the user activates the game of the game device 1 on the touch display 100. Here, explanation is provided according to the example shown in FIGS. 3A to 3E described above.

When the user activates the game of the game device 1, the controller 210 displays the level selection screen (FIG. 2A) on the display 120 (display screen) of the game device 1. When the user selects level 6, for example, on the level selection screen, the controller 210 acquires information on the selected level 6. Next, the controller 210 presents a problem, which corresponds to level 6 selected by the user, to the user. For example, the controller 210 refers to the problem information 222, and acquires or creates the map M of the problem corresponding to level 6 and the correct route corresponding to the map M. Next, the controller 210 sets the pieces P1 for use in the problem, and the transit points Pt located on the correct route. In the map information D1, the controller 210 registers information on the presence or absence (i.e., “1” or “0”) of the start point Ps, the transit point Pt, and the goal point Pg in the fields of “start point”, “transit point”, and “goal point” corresponding to the respective cells (see FIG. 6).

Then, the controller 210 displays the pieces P1 in the area AR1, and the map M in the area AR2 (FIG. 3A). As described above, the controller 210 executes the processing at the start of the game.

When the processing at the start of the game is finished, the controller 210 waits for an operation input from the user. Specifically, in step S11 of FIG. 10, the controller 210 determines whether the user has selected the piece P1.

When it is determined that the user has selected the piece P1 (YES in S11), in step S12, the controller 210 determines whether the user has designated the position of the piece P1. For example, the user touches a desired position on the map M in the area AR2 after touching a desired piece P1 in the area AR1. The controller 210 thereby acquires the designated position indicated by the user.

Next, in step S13, the controller 210 determines whether the designated position is within the area of the map M. If the designated position is within the area of the map M (YES in S13), the processing proceeds to step S14.

In contrast, if the designated position is outside the area of the map M (NO in S13), that is, if at least a part of the piece P1 is located outside the area of the map M, as shown in FIG. 8C, for example, the processing proceeds to step S15. In step S15, the controller 210 places the piece P1 back to the position of the initial setting, that is, the original position in the area. AR1. After that, the processing proceeds to step S27 to wait for an operation input by the user.

In step S14, the controller 210 determines the shortest distance between the center C0 of the piece P1 and the grid Gr. Specifically, the controller 210 calculates a distance from the center C0 of the piece P1 to each of the four grids Gr existing at the periphery of the center C0, and determines the shortest distance. For example, as illustrated in the enlarged view of one cell in FIG. 9, it is determined in which area of the four circles whose respective centers are the four grids Gr the center C0 of the piece P1 is included.

Next, in step S16, the controller 210 determines whether there exists the grid Gr that can be the shortest distance grid. Specifically, the controller 210 determines whether there exists a circle including the center C0 of the piece P1 among the four circles whose respective centers are the four grids Gr. If the above condition is satisfied (YES in S16), the processing proceeds to step S17. Meanwhile, if the above condition is not satisfied (NO in S16), in other words, if the center C0 of the piece P1 is not included in any of the four circles whose respective centers are the four grids Gr, and is located in an area near the center of the cell, the processing proceeds to step S23.

In step S17, the controller 210 sets the coordinates of the piece P1 to be the coordinates of the grid Gr. The controller 210 registers the coordinates of the grid Gr in the field of “grid coordinates” corresponding to the piece P1 in the piece information D2 (FIG. 7).

Next, in step S18, the controller 210 updates the selection permitted number N (piece counter) associated with the piece P1. For example, when the coordinates of the grid Gr are set on the piece P1 with which “2” is associated as the selection permitted number N, the selection permitted number N is updated from “2” to “1”.

Next, in step S19, the controller 210 updates the information on the map M (i.e., the map information D1). Specifically, in the map information D1 (FIG. 6), the controller 210 registers information on the presence or absence (i.e., “1” or “0”) of the route element R0 in the fields of “route element” of the cells corresponding to the grid Gr at which the coordinates of the piece P1 are set.

Next, in step S20, the controller 210 executes the processing (“piece display processing” to be described later) of displaying the piece P1 on the map M at the area AR1.

Next, in step S21, the controller 210 records the operation by the user. After that, in step S22, the controller 210 executes the processing (“correctness determination processing” to be described later) of determining whether the created route is correct or not (correctness).

In step S23 the controller 210 updates the selection permitted number N (piece counter) associated with the piece P1. Here, the controller 210 does not set the coordinates of the grid Gr on the piece P1, but decrements the selection permitted number N by one.

Next, in step S24, the controller 210 updates the map information D1 (FIG. 6). Here, since there exists no grid Gr at which the coordinates of the piece P1 are set, the controller 210 registers, for example, the specific information indicating error, indefiniteness, or the like, in the field of “route element” of the cell corresponding to the coordinates of the piece P1. If the user changes the position of the piece P1, and the coordinates of the grid Gr are set on the aforementioned piece P1, the controller 210 updates the information in the field of “route element” so that the field represents the presence or absence (i.e., “1” or “0”) of the route element R0.

In step S25 the controller 210 executes the “piece display processing” to be described later. In step S26, the controller 210 records the operation by the user. After that, the processing proceeds to step S27 to wait for an operation input by the user.

### Piece Display Processing

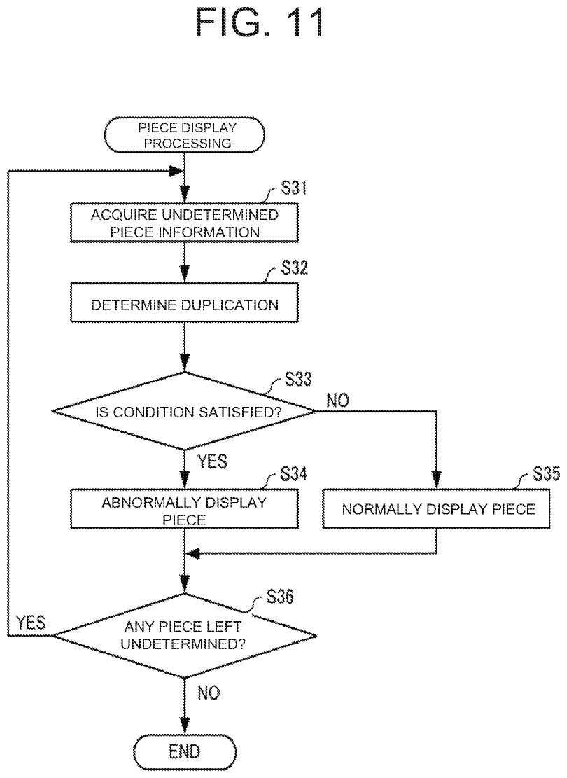

Next, referring to FIG. 11, the piece display processing will be described.

In step S31, the controller 210 acquires information on the piece P1 not determined yet. Specifically, the controller 210 acquires information on the piece P1 for which the piece display processing has not been executed among the plurality of pieces P1 registered in the piece information D2 (FIG. 7).

In step S32, the controller 210 determines whether or not the piece P1 which has been acquired overlaps a different piece P1 already arranged on the map M, the start point Ps, the transit point Pt, or the goal point Pg. Specifically, the controller 210 performs the above-described determination processing on the basis of the coordinates of the grid Gr associated with the acquired piece P1.

If the acquired piece P1 overlaps a different piece P1 or the like (YES in S33), the processing proceeds to step S34. In contrast, if the acquired piece P1 does not overlap a different piece P1 or the like (NO in S33), the processing proceeds to step S35.

In step S34, the controller 210 displays (abnormally displays) the piece P1 on the map M in a display mode of indicating that the piece P1 overlaps a different piece P1. For example, the controller 210 displays (abnormally displays) such a piece P1 in a color (for example, red indicating abnormality) different from the color (for example, green indicating normality) of the different piece P1 which has been normally arranged. In contrast, in step S35, the controller 210 displays (normally displays), for example, the piece P1 in a color (for example, green) indicating normality.

In step S36, the controller 210 determines whether there is a piece P1 not determined yet. Specifically, the controller 210 determines whether there exists a piece P1 for which the piece display processing has not been executed in the piece information D2. If there is a piece P1 not determined yet (YES in S36), the processing returns to step S31, and the controller 210 repeats the above processing. If there is no undetermined piece P1 (NO in S36), the processing is ended. As the above processing is repeated, the state of the display screen transitions the states as shown in FIGS. 3B to 3D.

### Correctness Determination Processing

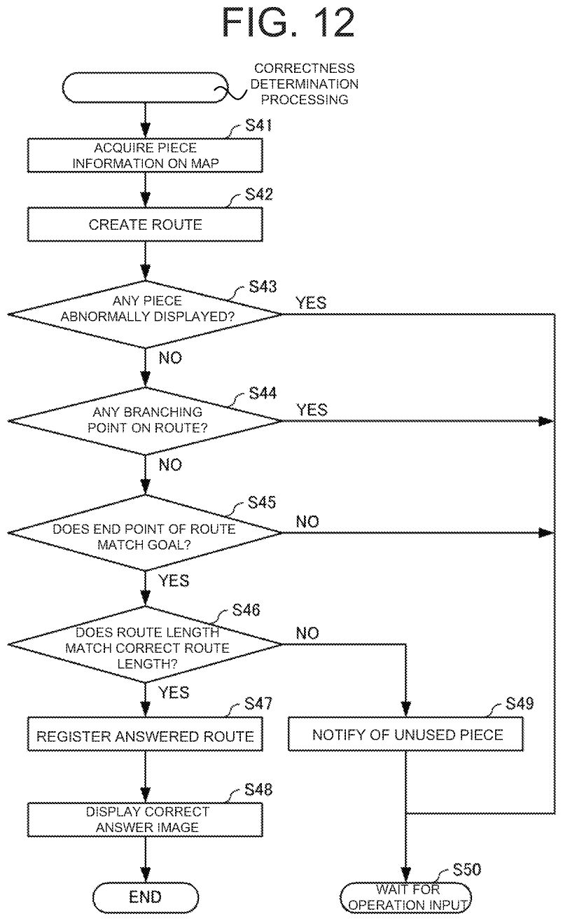

Next, referring to FIG. 12, the correctness determination processing will be described.

In step S41, the controller 210 acquires information on the pieces P1 registered in the map information D1 (FIG. 6). Specifically, the controller 210 acquires information on the route elements, i.e., “1” in the fields of “route element” of the map information D1.

Next, in step S42, the controller 210 creates a route corresponding to the operation by the user. Specifically, the controller 210 creates a route following the route elements R0 and the transit points Pt, on the basis of the information on the route elements and the transit points, i.e., “1” in the fields of “route element” and “1” in the fields of “transit point”.

Next, in step S43, the controller 210 determines whether the created route includes an abnormally displayed piece P1. Specifically, the controller 210 makes a determination on the basis of the information in the field of “duplication” of the piece information D2 (FIG. 7). If the aforementioned condition is satisfied (YES in S43), the processing proceeds to step S50 to wait for an operation input by the user. If the aforementioned condition is not satisfied (NO in S43), the processing proceeds to step S44.

Next, in step S44, the controller 210 determines whether there exists a branching point on the created route. That is, the controller 210 determines whether the route from the start point Ps to the goal point Pg branched or not in the middle. Specifically, the controller 210 determines the presence or absence of the branching point on the basis of the information in the field of “route element” of the map information D1 (FIG. 6). If the above condition is satisfied (YES in S44), the processing proceeds to step S50. If the above condition is not satisfied (NO in S44), the processing proceeds to step S45.

Next, in step S45, the controller 210 determines whether the end point created route matches with the goal point Pg. In other words, the controller 210 determines whether the coordinates of the end point of the route match with the coordinates of the goal point Pg. If the above condition is satisfied (YES in S45), the processing proceeds to step 546. If the above condition is not satisfied (NO in S45), the processing proceeds to step S50.

Next, in step S46, the controller 210 determines whether the length of the created route (route length) matches with the length of the correct route (correct route length). If the above condition is satisfied (YES in S46), the processing proceeds to step S47. If the above condition is not satisfied (NO in S46), the processing proceeds to step S49.

Next, step S47, the controller 210 registers the created route, more specifically, the answered route given by the user. Specifically, the controller 210 registers the answered route in the route information D3.

Next, in step S48, the controller 210 displays a correct answer image on the display screen (FIG. 3E). The controller 210 may display performance results information such as the time taken from the start of the game to the give the correct answer on the display screen.

In step S49, the controller 210 notifies that not all of the plurality of pieces P1 set for the problem have been used, that is, there being a selectable (unused) piece P1. For example, in the area AR1, the controller 210 may change the color of the piece P1 of which the selection permitted number N is not “0” but is a number that is greater than or equal to may cause the image of the piece P1 to blink on and off, or may display a message indicating existence of an unused piece P1.

In step S50, the controller 210 waits for an operation input from the user. When the created route is not determined to be correct, the controller 210 continues to receive the operation inputs from the user. For example, when the controller 210 receives an operation of changing the position of the piece P1 arranged on the map M from the user, the controller 210 executes the processing shown in FIGS. 10 to 12 again.

Alternatively, the controller 210 may determine correctness of the route created by the user on the basis of any one of the processes of steps S43 to S46 described above. Also, the controller 210 may determine correctness of the route created by the user by combining any two or more of the processes of steps S43 to S46 described above.

As described above, the game of the game device 1 according to the embodiment of the present disclosure is to create a route so that the created route can be the correct route (shortest route) by using of all of the pieces P1 given, and passing all of the checkpoints (transit points Pt) in the middle on the way from the start point Ps to the goal point Pg. In this way, cognitive functions such as planning ability and visuospatial cognition can be improved.

The game device 1 according to the present disclosure can be introduced into a user terminal such as a computer, a tablet terminal, and a smartphone owned by the user. Also, the user can play the game by downloading the game program stored in a cloud server and executing the same by the user terminal.

It should be noted that the game device 1 according to the present disclosure may be constituted by freely combining the embodiments as described above, or by modifying or partially omitting the embodiments as appropriate within the scope of the invention defined in each claim.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. A game device which displays a start point and a goal point corresponding to a problem on a display screen, and also arranges and displays a plurality of objects between the start point and the goal point in accordance with an operation by a user, thereby creating a route between the start point and the goal point, the game device comprising:
a display including the display screen;
a reception processing device which receives an operation by which the user selects the plurality of objects individually, and an operation by which the user specifies an arrangement position of a selected object, which is an object selected by the user, from among the plurality of objects;
a display control device which displays the start point and the goal point on the display screen, displays the plurality of objects in a first area on the display screen such that the plurality of objects are individually selectable by the user, and arranges and displays, accordance with the operation by the user, the selected object, which is selected by the user from among the plurality of objects displayed in the first area, at a designated position specified by the user in a second area including the start point and the goal point on the display screen; and
a determination processing device which determines correctness of the route created by the plurality of objects arranged in the second area.

2. The game device according to claim 1, wherein each of the plurality of objects includes a partial route for creating the route.

3. The game device according to claim 2, wherein the determination processing device determines the correctness of the route created by assuming a plurality of the partial routes that are continuous of a whole of the plurality of the partial routes, which are included in a plurality of the selected objects, arranged in the second area, to be an integrated route.

4. The game device according to claim 1, wherein the determination processing device determines that the route is correct on condition that at least the route connects the start point and the goal point.

5. The device according to claim 4, wherein the determination processing device determines that the route is correct further on condition that a length of the route matches with a length of a predetermined route corresponding to the problem.

6. The game device according to claim 4, wherein the determination processing device determines that the route is correct further on condition that all of the objects set for the problem are arranged in the second area.

7. The game device according to claim 4, wherein the determination processing device determines that the route is correct further on condition that the route is created without being branched in a middle of the route.

8. The game device according to claim 4, wherein:
the display control device further displays a transit point on the display screen; and
the determination processing device determines that the route is correct further on condition that the route passes the transit point.

9. The game device according to claim 1, wherein the display control device displays a plurality of squares to arrange a plurality of the selected objects in the second area, and also arranges and displays the selected object in a square out of the plurality of squares corresponding to the designated position specified by the user.

10. The game device according to claim 1, wherein:
the object is associated with a number by which the object is selectable by the user; and
the display control device displays the number on the object, and decrements the number each time the object is selected by the user.

11. A game control method of displaying a start point and a goal point corresponding to a problem on a display screen, and also arranging and displaying a plurality of objects between the start point and the goal point in accordance with an operation by a user, thereby creating a route between the start point and the goal point, the game control method executed by one or more processors, the game control method comprising:
displaying the start point and the goal point on the display screen, and displaying the plurality of objects in a first area on the display screen such that the plurality of objects are individually selectable by the user;
receiving an operation by which the user selects the plurality of objects individually, and an operation by which the user specifies an arrangement position of a selected object, which is an object selected by the user, from among the plurality of objects;
arranging and displaying, in accordance with the operation by the user, the selected object, which is selected by the user from among the plurality of objects displayed in the first area, at a designated position specified by the user in a second area including the start point and the goal point on the display screen; and
determining correctness of the route created by the plurality of objects arranged in the second area.

12. A non-transitory computer-readable recording medium having stored thereon a game program which displays a start point and a goal point corresponding to a problem on a display screen, and also arranges and displays a plurality of objects between the start point and the goal point in accordance with an operation by a user, thereby creating a route between the start point and the goal point, the game program causing one or more processors to execute:
displaying the start point and the goal point on the display screen, and displaying the plurality of objects in a first area on the display screen such that the plurality of objects are individually selectable by the user;
receiving an operation by which the user selects the plurality of objects individually, and an operation by which the user specifies an arrangement position of a selected object, which is an object selected by the user, from among the plurality of objects;
arranging and displaying, in accordance with the operation by the user, the selected object, which is selected by the user from among the plurality of objects displayed in the first area, at a designated position specified by the user in a second area including the start point and the goal point on the display screen; and
determining correctness of the route created by the plurality of objects arranged in the second area.
